(19) United States
(12) Patent Application Publication
(10) Pub. No.: US 2023/0148235 A1
(43) Pub. Date: May 11, 2023

(54) AUTOMATIC MOP BUCKET

(71) Applicant: Tony Brown, Severn, MD (US)

(72) Inventor: Tony Brown, Severn, MD (US)

(21) Appl. No.: 17/982,800

(22) Filed: Nov. 8, 2022

Related U.S. Application Data
(60) Provisional application No. 63/277,516, filed on Nov. 9, 2021.

(51) Int. Cl. A47L 13/59; A47L 13/22

(52) U.S. Cl. CPC A47L 13/59; A47L 13/22; A47L 11/4016

(57) ABSTRACT

An apparatus including a container including an interior area for housing a liquid; a plurality of casters in operative connection with the container for container movement; a liquid inlet port configured to receive a liquid into the interior area; a liquid outlet port configured to discharge liquid from the interior area; and a sealed chamber enclosing a pump in fluid connection with the interior area and the liquid outlet port, a pump motor to drive the pump, and a power source to provide electrical power to the motor, wherein the motor and the power source are in operative connection via at least one circuit, wherein the power source is operative to deliver power to the pump, and wherein the pump is operative to draw liquid from the interior to be discharged therefrom.

### BACKGROUND OF THE INVENTION

### 1. Field of the Invention

The exemplary embodiments relate to buckets or containers for mopping, cleaning, or other actions requiring the use of liquids. The exemplary embodiments further relate to containers that are automatically filled and automatically emptied by a pump.

### 2. Description of Related Art

There have been previous means for mopping or cleaning as well as previous means for containing a liquid for use during such actions. However, these means fail to suffice as sufficient mopping or cleaning means, as well as fail to suffice as sufficient means for containing liquids for use during such actions. For example, a conventional mop bucket must be manually filled and drained. A conventional mop requires continued submerging in a liquid to apply the liquid to a surface or floor and continued squeezing to drain the liquid from the mop pad. In addition, other liquid using cleaning instruments, such as Swiffer® mops, fail to properly clean a surface to some user's liking.

Therefore, what is desired in exemplary embodiments is a container for housing a liquid to facilitate mopping, cleaning, or other actions that is automatically filled through operative connection with a liquid source and automatically emptied by a pump. Additionally, exemplary embodiments include a filter for removal of debris and bacteria from the liquid within the exemplary container. Further, exemplary embodiments additionally include an operatively connectable automatic mop configured to discharge and intake a liquid through or adjacent to a mop head or pad.

### SUMMARY OF THE INVENTION

Exemplary embodiments comprise an apparatus, comprising: a container including an interior area configured to house a liquid therein; a plurality of casters in operative connection with a lower portion of the container to permit the container to be moved about on a floor or other support surface; a liquid inlet port configured to receive a liquid from an external liquid source into the interior area; a liquid outlet port configured to discharge liquid from the interior area; and a sealed chamber enclosing a pump in fluid connection with the interior area and the liquid outlet port, a pump motor to drive the pump, and a power source to provide electrical power to the pump motor, wherein the pump motor and the power source are in operative connection via at least one circuit, wherein the power source is operatively configured to selectively deliver electrical power to the pump motor via the circuit to cause operation of the pump, and wherein the pump is thereby selectively operative to draw liquid from the interior area and to cause the liquid to be discharged through the liquid outlet port.

Alternative exemplary embodiments further comprise at least one filter for removal of debris from the liquid, wherein the filter is in fluid connection with the liquid outlet port.

In alternative exemplary embodiments the container further includes a spill resistant rim at an upper portion of the container.

In alternative exemplary embodiments the container further includes a bladed mixer disposed within the interior area and a mixer motor sealed from the liquid, wherein the mixer motor is in operative connection with the power source via the circuit and is operative to cause the bladed mixer to rotate to cause movement of the liquid in the interior area.

Alternative exemplary embodiments further comprise an automatic mop, wherein the automatic mop is in operative connection with the container and includes: a mop head, a liquid discharge line and a liquid discharge port, a liquid intake line and a liquid intake port, a mop pump in operative fluid connection with the liquid and a mop motor sealed from the liquid, wherein the liquid discharge port and the liquid intake port are positioned adjacent to the mop head, and wherein the liquid discharge line extends from the liquid discharge port to the interior area and the liquid intake line extends from the liquid intake port to the interior area, wherein the mop motor is in operative connection with the circuit and the mop pump, and wherein the mop motor is selectively operative to cause the pump to move liquid from the interior area through the liquid discharge line and out the liquid discharge port and to move liquid from an external surface through the liquid intake port and through the liquid intake line to the interior area.

Alternative exemplary embodiments further comprise a wet/dry vacuum in operative connection with the container, wherein the wet/dry vacuum is configured to remove liquids or solids from a surface.

In alternative exemplary embodiments, the apparatus as comprising a bucket for a mop, further comprises a wringer with a handle configured to wring out a mop head positioned within an interior area of the wringer.

In alternative exemplary embodiments the liquid inlet port and the liquid outlet port comprises a combined liquid inlet port and liquid outlet port with a selectively changeable valve configured to permit the combined liquid inlet port and liquid outlet port to selectively serve as one of a liquid input port and a liquid output port.

Alternative exemplary embodiments comprise: a container including an interior area configured to house a liquid therein; a plurality of casters in operative connection with a lower portion of the container, to permit movement of the apparatus along a floor or other support surface; a liquid inlet port configured to receive a liquid from an external liquid source into the interior area; a liquid outlet port configured to discharge liquid from the interior area; and a pump in fluid connection with the interior area and the liquid outlet port, the pump being selectively operative to draw liquid from the interior area and be discharged through the liquid outlet port.

In alternative exemplary embodiments the pump is manually operated.

In alternative exemplary embodiments the pump is electrically driven.

Alternative exemplary embodiments further comprise an electric circuit to selectively provide electrical power to drive the electrically driven pump

Alternative exemplary embodiments further comprise a sealed chamber enclosing the electrically driven pump, along with an electric pump motor that drives the pump and a power source configured to selectively provide electrical power to the electric pump motor.

In alternative exemplary embodiments the power source comprises a battery and a power switch located on an outside surface of the sealed chamber permits a user to selectively connect the battery to the electric pump motor to operate the electrically driven pump.

Alternative exemplary embodiments comprise a mop bucket, comprising: a container including an interior area configured to house a liquid therein; a plurality of casters in operative connection with a lower portion of the container, to permit the mop bucket to be moved about on a floor or other support surface; a wringer with a handle, configured to wring out a mop head positioned within an interior area of the wringer; a liquid inlet port configured to receive a liquid from an external liquid source into the interior area; a liquid outlet port configured to discharge liquid from the interior area; and a pump in fluid connection with the interior area and the liquid outlet port, the pump being selectively operative to draw liquid from the interior area and to cause the liquid to be discharged through the liquid outlet port.

### BRIEF DESCRIPTIONS OF THE DRAWINGS

These and/or other aspects of the exemplary embodiments will become apparent and more readily appreciated from the following description thereof, taken in conjunction with the accompanying drawings of which:

FIG. 1 is a left side view of an exemplary container;

FIG. 2 is a top plan view of an exemplary container;

FIG. 3 is a top plan view of an exemplary container operatively connected to an exemplary liquid source;

FIG. 4 is a top plan view of an alternative exemplary container operatively connected to an exemplary liquid source and an exemplary drain;

FIG. 5 is a left side plan view of an exemplary container;

FIG. 6 is a perspective view of an exemplary clamp;

FIG. 7 is a plan view of an exemplary liquid line connector;

FIG. 8 is a plan view of an exemplary liquid line and an exemplary connector;

FIG. 9 is a plan view of an exemplary liquid connector;

FIG. 10 is left side view of an exemplary container including an exemplary mop wringer;

FIG. 11 is a left side view of an alternative exemplary container;

FIG. 12 is a perspective view of an exemplary chamber;

FIG. 13 is a front plan view of an exemplary chamber;

FIG. 14 is a perspective view of an exemplary chamber interior including an exemplary pump;

FIG. 15 is a perspective view of an exemplary liquid line including an exemplary filter in operative connection therewith;

FIG. 16 is a perspective view of an exemplary liquid line;

FIG. 17 is a perspective view of an alternative exemplary embodiment including an exemplary automatic mop; and

FIG. 18 is a perspective view of an alternative exemplary embodiment including an exemplary wet/dry vacuum.

### DESCRIPTION OF INVENTION

Reference will now be made in detail to the exemplary embodiments which are illustrated in the accompanying drawings, wherein like reference numerals refer to the like elements throughout. The exemplary embodiments are described below with reference to the figures.

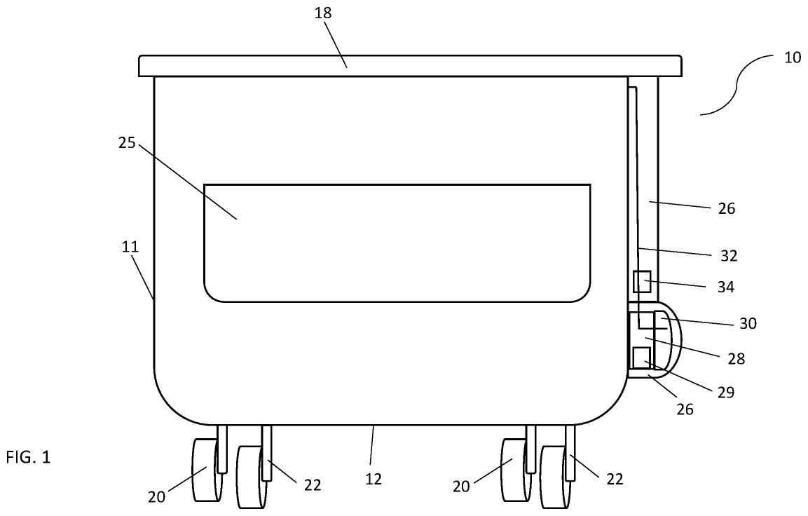

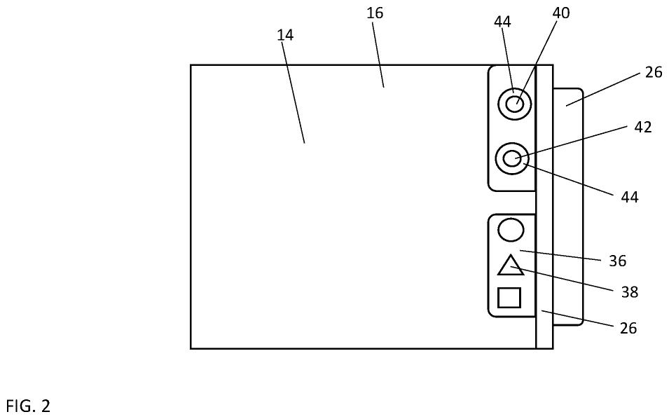

FIGS. 1-2 show an exemplary container 10. The exemplary container 10 comprises a bin or bucket or pail of any shape that has at least one wall 11 and a bottom 12 that bound an interior area 14. The exemplary container 10 includes an opening 16 at a top disposed away from the bottom 12. The exemplary opening 16 is continuously bounded by a spill resistant rim 18. Of course, this container arrangement is merely exemplary, and in other embodiments, other arrangements may be used.

The exemplary container 10 includes wheels or casters 20. The exemplary casters 20 are in operative connection with an underside of the container 10. For example, the casters 20 are in operative connection with the underside of the container 10 through respective downward extending flanges 22. Further, the exemplary flanges 22 may be operatively connected with a respective horizontal caster axel 24 (not shown). The exemplary casters 20 and flanges 22 are configured to be removable. Additionally, the casters 20 are configured to rotate relative to the flanges 22. However, this caster arrangement is merely exemplary, and in other embodiments, other arrangements used.

In alternative exemplary embodiments, the exemplary container 10 further includes at least one basket 25 in operative connection with the at least one container wall 11. The exemplary basket 25 is configured to hold cleaning supplies or other cleaning utensils. As can be appreciated, this container arrangement is merely exemplary, and in other embodiments, other arrangements may be used.

In exemplary embodiments, the exemplary container 10 includes a watertight chamber 26 in operative connection with a wall 11 of the container 10. The exemplary chamber 26 is sealed off from entrance of liquid by any combination of seals, gaskets, or other liquid resistant structures.

The exemplary chamber 26 includes, operatively positioned therein, a pump 28, a pump motor 29, a battery 30, at least one circuit 32, and a power connector 34. In exemplary embodiments, the pump 28, the pump motor 29, the battery 30, and the power connector 34 are in operative connection with the at least one circuit 32. Of course, this chamber arrangement is merely exemplary, and in other embodiments, other chamber arrangements may be used.

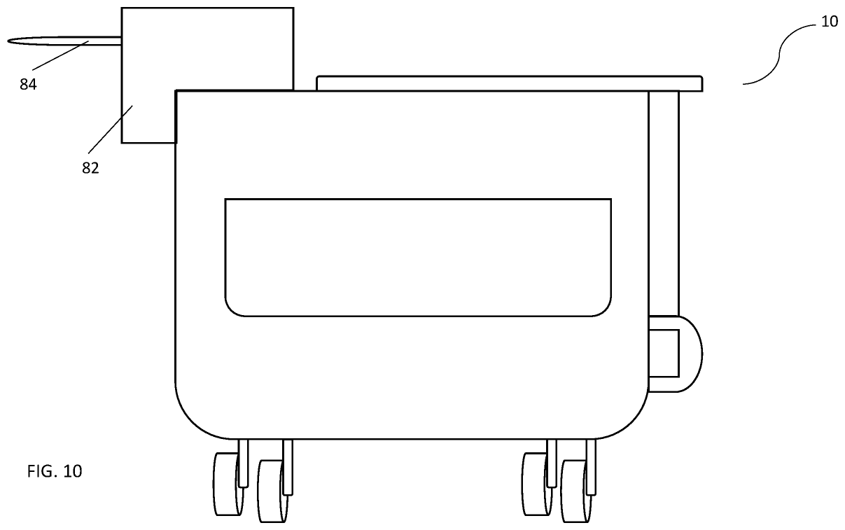

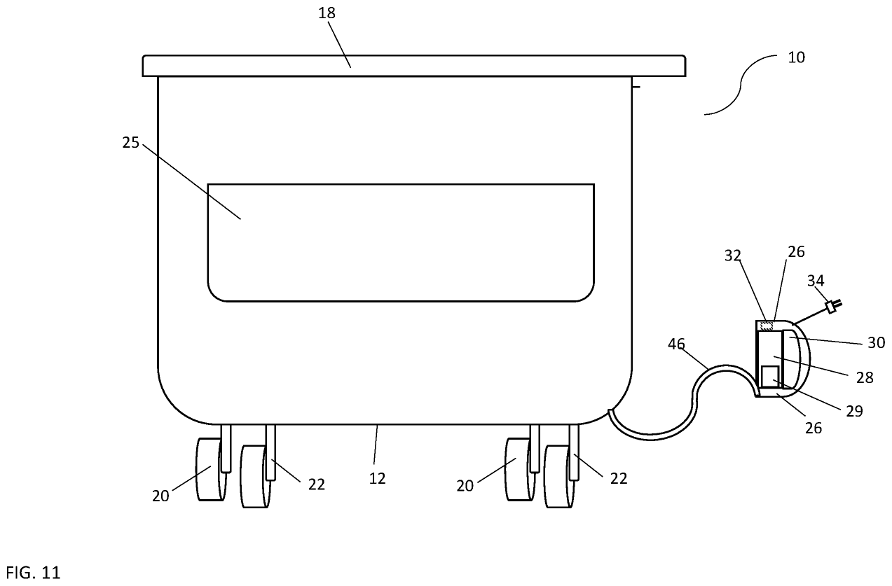

In exemplary embodiments, the exemplary power connector 34 is operative to receive a power cord 35 in operative releasable engagement therewith. The exemplary power cord 35, best shown in FIGS. 10-11, is configured to be operatively connectable with a power source and is operative to cause electrical energy to be transferred via the power cord 35 to the power connector 34. The at least one circuit 32 is operative to receive the electrical energy from the power connector 34 and transfer/convert the electrical energy to the battery 30 to cause the battery 30 to be charged using external AC power. The battery 30 is operative to supply power to the pump motor 29, and the pump motor 29 is operative to cause operation of the pump 28.

In alternative exemplary embodiments, the exemplary power connector 34 is operative to provide power from the power cord 35 directly to the pump motor 29 for operation of pump 28. That is, in such arrangements, the battery 30 may be foregone. In further alternative exemplary embodiments, the exemplary power cord 35 is in fixed operative connection with the circuit 32 and is configured to be extended and retracted via a spring-loaded wheel from a power cord chamber in operative connection with the container 10. The power cord 35 may be extended from the power cord chamber to be connected with a power source outlet external to the container 10. In still further alternative exemplary embodiments, the pump 28 may be drive by an AC motor, thereby eliminating the need for a battery and battery charger circuit. Of course, as should be understood, these power arrangements are merely exemplary, and in other embodiments, other arrangements may be used.

As shown in FIG. 2, the exemplary container 10 includes a switch plate 36. The exemplary switch plate 36 is in operative connection with the container 10 adjacent the watertight chamber 26. The exemplary switch plate 36 includes at least one switch 38 in operative connection with the at least one circuit 32. In exemplary embodiments, manual manipulation of the switch 38 to an on position is operative to cause power to be supplied to the pump motor 29 causing operation of the pump 28. Similarly, manual manipulation of the switch 38 to an off position is operative to cause power supplied to the pump motor 29 and operation of pump 28 to cease. As can be appreciated, these switch arrangements are merely exemplary, and in other embodiments, other switch arrangements may be used.

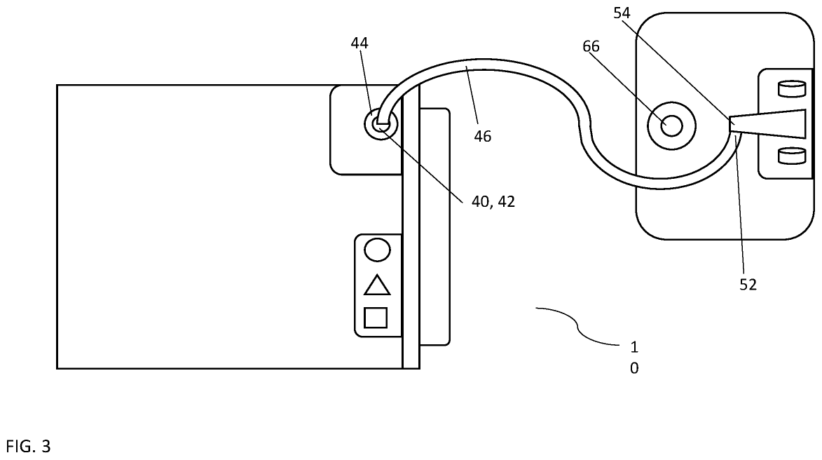

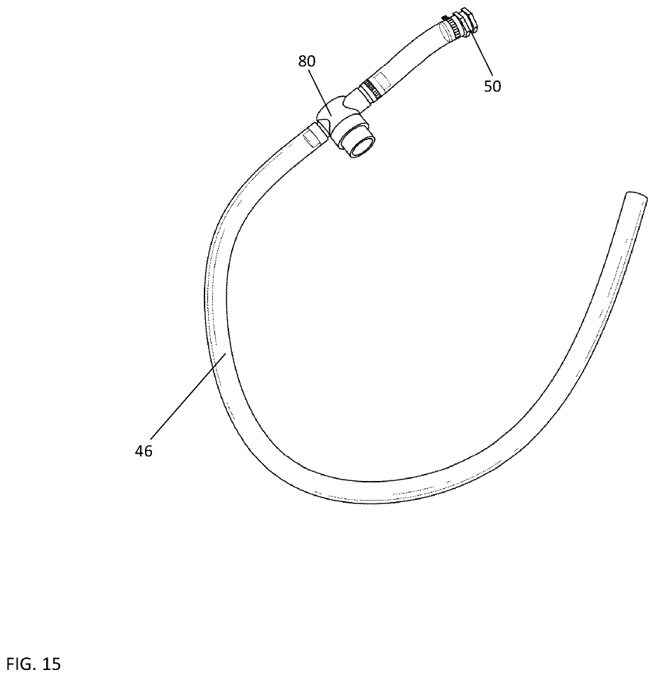

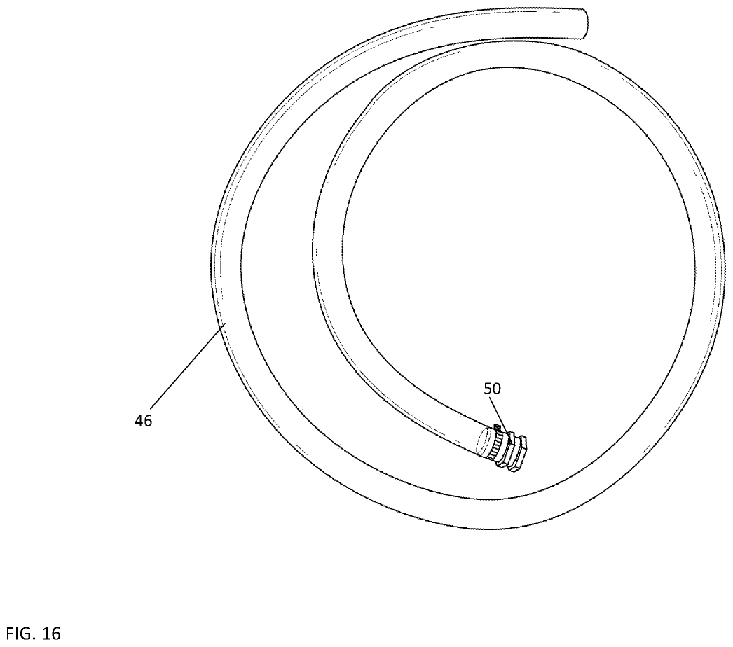

As shown in FIGS. 2-3, the exemplary container 10 further includes a liquid inlet 40 and a liquid outlet 42. However, as will become apparent from this disclosure, alternative exemplary embodiments of container 10 include a combined liquid inlet and liquid outlet, best shown in FIG. 3. The exemplary liquid inlet 40 and liquid outlet 42 each include a connector 44, best shown in FIG. 9. The exemplary connector 44 comprises any connector operative to receive a liquid line 46 in operative connection therewith. The exemplary connector 44 comprises a male or female threaded portion that is operatively releasably engageable with a liquid line connector 50 of liquid line 46 that includes the other of the male or female threaded portion, best shown in FIGS. 15-16. The exemplary connectors 44 and 50 include in operative connection therewith any combination of gaskets, seals, or other leak resistant structures. In alternative exemplary embodiments, the connectors 44 and 50 comprise quick connect fittings. Of course, these connector arrangements are merely exemplary, and other connectors or fittings may be used.

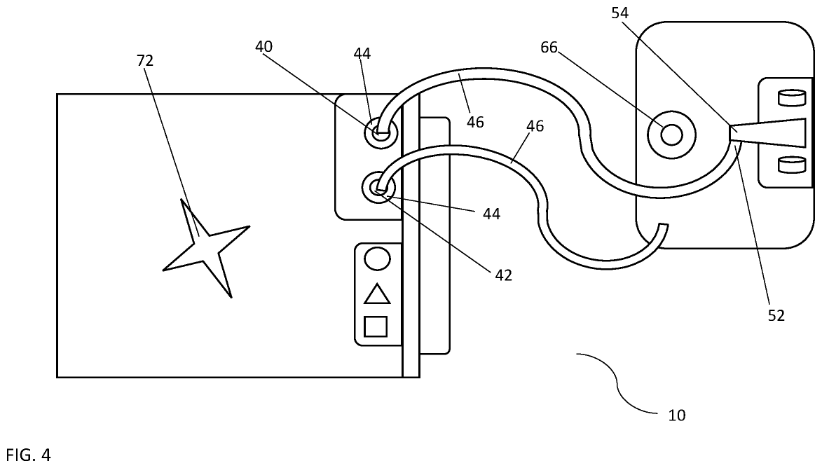

In exemplary embodiments, as shown in FIGS. 15-16, the exemplary liquid line 46 comprises a clear hose. However, as can be appreciated, exemplary liquid line 46 may comprise any structure operative to deliver liquid through the liquid inlet 40 into the container 10, or to carry liquid away from the liquid outlet 42. In alternative exemplary embodiments, two liquid lines 46 may be used, one for connection to connector 44 of liquid inlet 40 and one for connection to connector 44 of liquid outlet 42, best shown in FIG. 4.

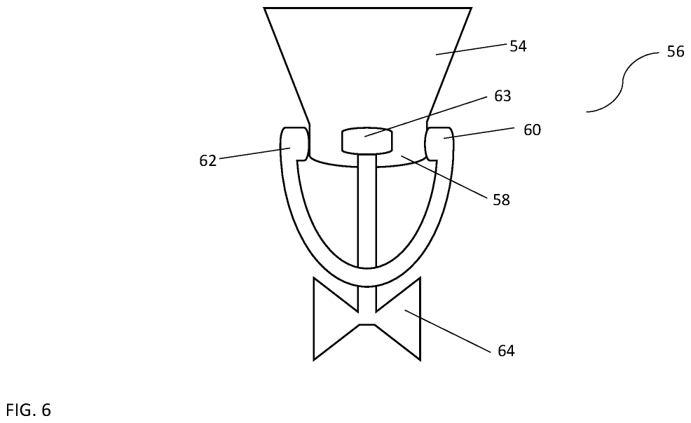

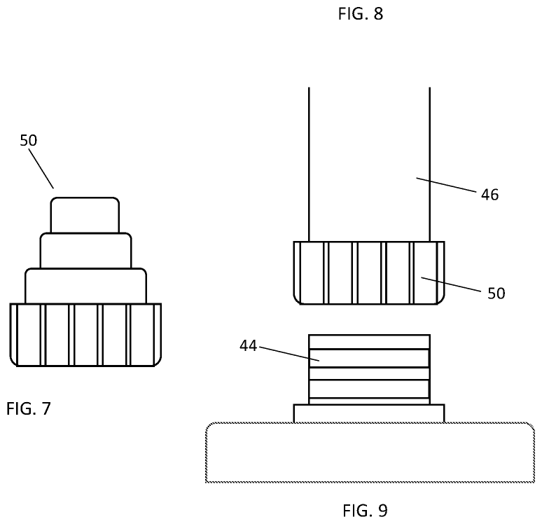

The exemplary liquid line 46 includes an end 52 disposed away from the liquid line connector 50. The end 52 is configured to be operatively, releasably engageable with a liquid source 54 such as the spout of a faucet of a sink, tub, or spigot. In alternative exemplary embodiments, the exemplary end 52 includes a clamp 56 in operative connection therewith, best shown in FIG. 6.

The exemplary clamp 56 is operative to maintain the end 52 in surrounding relation of a spout 58 of the faucet, spigot, or other water source. The exemplary clamp 56 includes first and second clamp arms 60 and 62, a clamp head 63, and a wing nut tightener 64. As the wingnut 64 is tightened, the clamps arms 60, 62 and the clamp head 63 increasingly apply pressure to the end 52 in surrounding relation of the spout 58 so that the end 52 remains engaged with the spout 58. However, as can be appreciated, these arrangements are merely exemplary, and in other embodiments, other arrangements maybe used.

In exemplary embodiments of the exemplary container 10, when the end 52 is engaged with the spout 58 and the liquid source 54 is turned to the on position, liquid is enabled to flow through the liquid line 46, through the liquid inlet 40, and into the interior area 14 of the container 10. The liquid within the interior area 14 of the container 10 is thereafter usable for cleaning, mopping, or other actions requiring a supply of liquid.

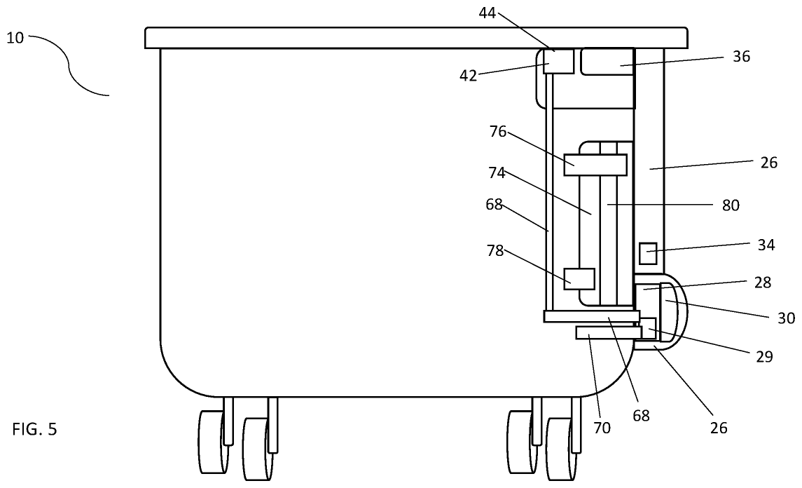

Now referring to FIG. 5, when the cleaning or other action is completed and the interior area 14 needs to be drained, the liquid line 46 is operatively connected to the liquid outlet 42 via its respective connectors 50 and 44. The end 52 of the liquid line 46 is directed toward a drain 66, for example, a drain of a sink or tub. The exemplary pump 28 is in operative connection with the liquid outlet 42 via a pump discharge line 68 that extends between the pump 28 and the liquid outlet 42. After switch 38 has been manually manipulated to the on position such that the pump 28 is caused by motor 29 to be operating, the pump 28 is operative to draw the liquid from within interior area 14 through a pump intake line 70. The liquid is received in the pump 28 from the pump intake line 70 and is caused to move by operation of the pump 28 from the pump into the pump discharge line 68. The exemplary pump discharge line 68 receives the liquid from the pump 28 and carries the liquid through the pump discharge line 68, through liquid outlet 42, and through liquid line 46 to be disposed of via drain 66. Of course, as can be appreciated, this container draining and pump arrangement is merely exemplary, and in other embodiments, other container draining, and pump arrangements may be used.

In alternative exemplary embodiments including a combined liquid inlet and liquid outlet, such embodiments also include a changeable valve, a first liquid path, and a second liquid path. In a first position of the exemplary changeable valve, the second liquid path is closed and liquid entering via the combined inlet and outlet from the liquid line 46 is caused to flow through the first liquid path into the interior area. When the exemplary valve is in the second position, the first liquid path is closed, and liquid is enabled to flow from the liquid discharge line 68 through the combined inlet and outlet into liquid line 46 to be drained in drain 66. However, this arrangement is exemplary, and other valve arrangements may be used.

In exemplary embodiments, pump 28 may comprise any pump suitable to move liquid from within interior area 14, through drain line 68, out of outlet 42, and through liquid line 46. For example, pump 28 may comprise a manual pump, a pedestal or submersible sump pump or the like, a jet pump including a motor and impeller, a centrifugal pump, or any other suitable pump and necessary structures.

As shown in FIG. 4, in alternative exemplary embodiments, the exemplary container 10 includes a bladed mixer 72 for causing movement to the liquid within interior area 72. In some exemplary embodiments, the exemplary mixer 72 may include a protective cage in surrounding relation thereof so as to protect a user's extremity, mop, or other instrument that is submerged in the liquid from contact with the blades of the mixer 72.

In further alternative exemplary embodiments, the exemplary container 10 includes a filter box 74 including a filter inlet port 76 and a filter outlet port 78. The exemplary filter box 74 includes therein any suitable removable filter 80 for removal of debris, bacteria, or other materials. In exemplary arrangements, liquid within interior area 14 is caused to move into filter box 74 via inlet port 76, is caused to be filtered by the filter 80 therein, and to exit filter box 74 via outlet port 78. The liquid may be caused to move through filter box 74 by movement of the liquid caused by a user or other instrument or device submerged in the liquid, movement of the liquid by mixer 72, or by operative connection with pump 28 or an additional pump with necessary structures to cause liquid to be drawn into the box 74 and forced therefrom.

In alternative exemplary embodiments, the exemplary filter 80 may be in operative connection with an interior of the liquid line 46 or liquid discharge line 68. In such arrangements, the exemplary filter 80 is configured to remove debris and other matter prior to the liquid reaching drain 66. In further alternative exemplary arrangements, the exemplary filter 80 may comprise a debris or matter catch, such as a screen, that is easily accessible and removable for cleaning thereof. Of course, these filtering arrangements are merely exemplary, and in other embodiments, other arrangements may be used.

In still further alternative exemplary embodiments, as shown in FIG. 10, the exemplary container 10 includes in operative connection therewith a wringer 82. The exemplary wringer 82 includes a handle 84 operatively connective thereto. The exemplary wringer 82 operates to squeeze a mop head positioned within an interior area of the wringer 82 by manual movement of handle 84 causing a moveable piece to squeeze the mop head between the moveable piece and an interior surface of a wall of the wringer. However, as can be appreciated, this arrangement is merely exemplary, and in other embodiments, other arrangements may be used.

Now referring to FIG. 11, in a further alternative exemplary embodiment, the exemplary container 10 may be formed completely separate from the pump 28. That is, the pump 28 may be manufactured within a separate housing from the container 10. The pump 28 is similar to the previous embodiment and includes at least one liquid line 46 detachably coupled to the container 10 and a power connector 34.

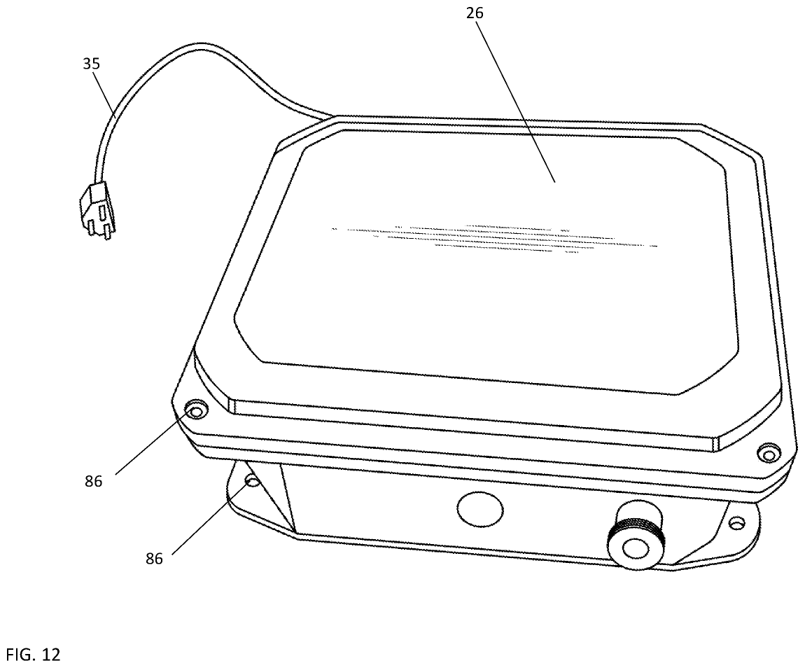

Now referring to FIGS. 12-14. There is shown therein an exemplary watertight chamber 26 including power cord 35. In the watertight chamber 26 arrangement shown in FIGS. 12-14, the exemplary chamber 26 is formed separately from the container 10. The exemplary chamber 26 may be operatively connected to the container 10 through any fixing or fastening means. However, in exemplary embodiments, the chamber 26 may be connected to the container 10 through a plurality of openings 86 configured to receive a fastener therethrough. Of course, the is arrangement is merely exemplary, and in other embodiments, other arrangements may be used.

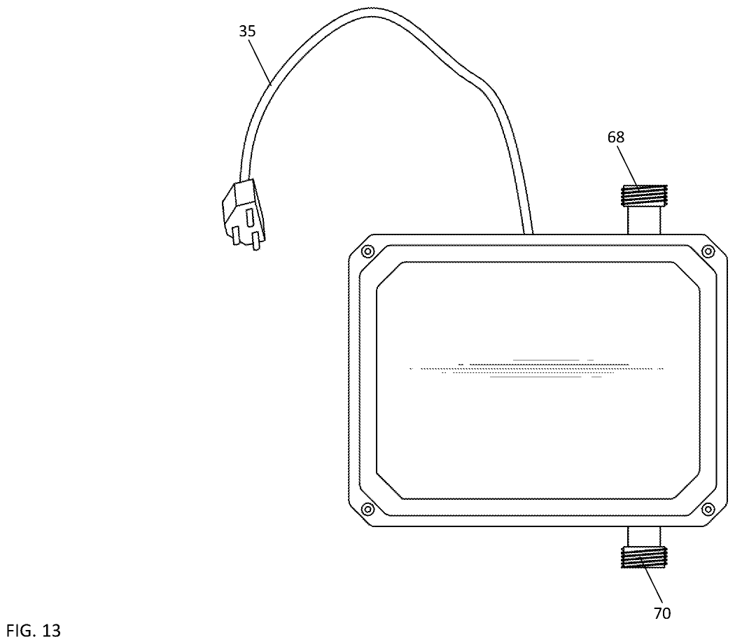

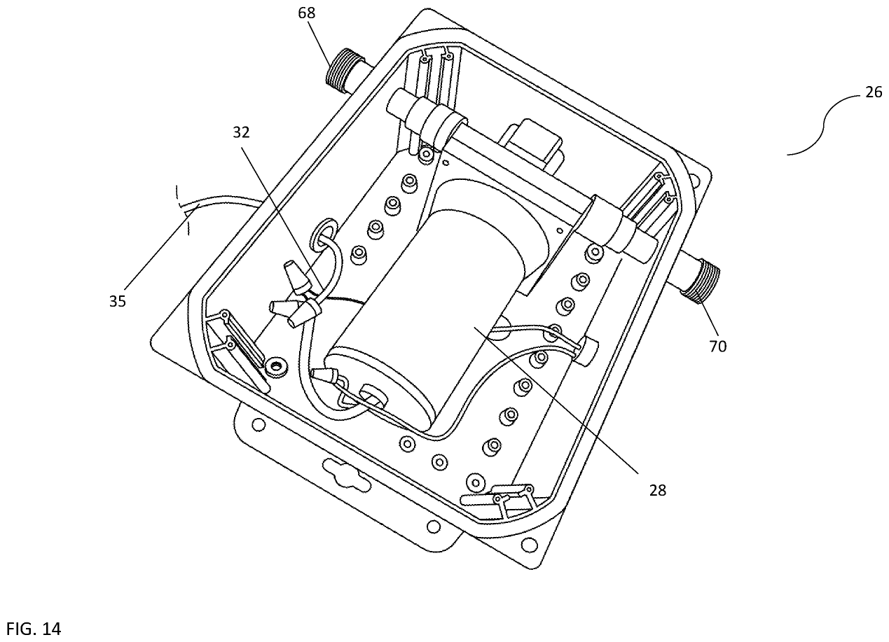

As shown in FIGS. 13-14, the exemplary chamber 26 includes a pump intake line 70 and a pump discharge line 68. The pump intake line 70 is configured to receive liquid removed from the interior area 14 during operation of the pump 28. The pump 28 is configured to discharge the liquid from the interior area 14 through the discharge line 68.

In alternative exemplary embodiments, liquid lines 46 are operatively connected to the discharge line 68 and the pump intake line 70. In such arrangements, liquid is drawn through the liquid line 46 into the pump intake line 70 and discharged through the pump discharge line 68 through liquid line 46 to drain 66. In such arrangements, the liquid inlet and outlet 40 and 42 may be foregone. Further, in such arrangements, the same liquid lines may be used for filling the interior area 14 with liquid. Of course, this arrangement is merely exemplary, and in other embodiments, other exemplary arrangements may be used.

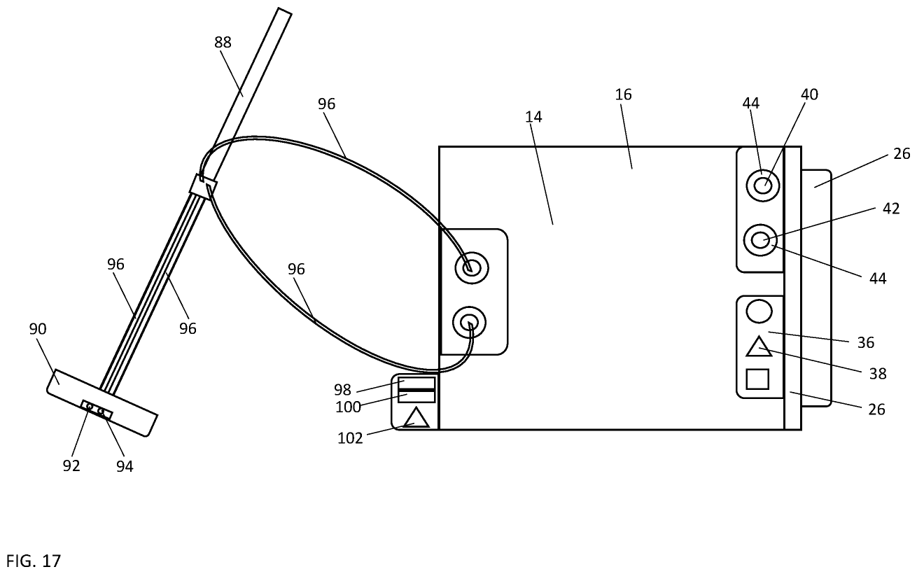

In alternative exemplary embodiments, as shown in FIG. 17, the exemplary container 10 includes in operative connection therewith, an automatic mop 88 configured to automatically discharge and intake a liquid through or adjacent to a mop head 90 or pad.

The exemplary automatic mop 88 includes a mop head 90 or pad with an integrated liquid discharge port 92 and liquid intake port 94. The exemplary ports 92 and 94 allow the mop head to discharge liquid for cleaning purposes, and to intake or suction up the liquid when too much liquid has been discharged, or when the mop head 90 is too wet. For example, the mop head 92 is moved into an area containing too much liquid and the liquid intake is actuated, thereby suctioning or intaking the liquid from the surface, or by absorbing the liquid with the head 90 and suctioning or intaking the liquid from the head 90.

The exemplary mop 88 further includes at least one liquid line 96, in some embodiments two liquid lines 96, extending from the interior area 14 of the container 10 to the mop head 90 or the respective liquid discharge 92 and intake ports 94. Additionally, the exemplary mop 88 includes a mop pump 98, mop pump motor 100, and at least one switch 102 all in operative connection with the at least one circuit 32 for control of the liquid discharge and intake. Of course, this arrangement is merely exemplary, and other arrangements may be used.

In further alternative exemplary embodiments, the exemplary container chamber 26 additionally includes an electronic system comprising a processor, a memory and processor readable medium, a receiver, a transmitter, at least one sensor, and a wired input and output port, for example, a USB port all in operative connection with the at least one circuit. In exemplary embodiments, the electrical system is operative to collect data from the various components of the system as well as the pump, battery, motor, mixer, filter, and switch box and sensors associated respectively therewith. The exemplary electrical system is operative to send and receive data via the transmitter, receiver, or wired input/output port. In exemplary arrangements, the exemplary system is operative to determine when any of the various components of the system and container are malfunctioning or otherwise not working properly, to connect with a Global Positioning System to determine a location of the container, or to monitor usage of liquids used in the container, for example, a volume of water, cleaning fluid or detergent, or any other material or liquid. Of course, as can be appreciated, these components and functions of the electrical system are exemplary, and in other embodiments, other components and functions may be used or achieved.

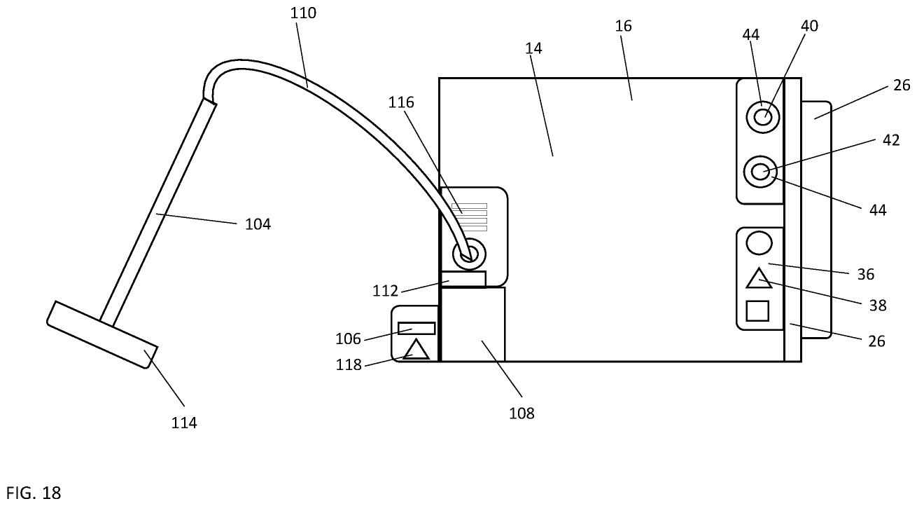

In further alternative exemplary embodiments, as shown in FIG. 18, the automatic mop bucket may be integrally formed within a conventional wet/dry vacuum 104. The exemplary wet/dry vacuum 104 is configured to remove dirt, dust, debris, solids or liquids from a surface. The exemplary wet/dry vacuum 104 includes a motor 106, a storage tank or storage bag 108, a length of hose 110, a filter 112, and a plurality of vacuum attachments 114. In some exemplary arrangements, the storage tank 108 may comprise the interior area 14 of the container 10. The exemplary wet/dry vacuum 104 further includes an air intake/outtake 116 and an on/off switch 118.

The exemplary wet/dry vacuum 104 is designed to be in operative connection with the container 10. The exemplary motor 106 is in operative connection with the circuit 32 and is configured to receive power from the power connector 34 or power cord 35 for operation of the motor 106. During operation, the motor 106 is operative to cause a suction force to be applied at an opening of an attachment 114. The suction force is operative draw liquids or solids through the opening of the attachment 114, through the length of hose 110, through filter 112, and into the storage tank or bag 108. The exemplary storage tank or bag 108 may be emptied through detachment from the container 10. Of course, this wet/dry vacuum arrangement is merely exemplary, and in other embodiments, other arrangements may be used.

In alternative exemplary embodiments, the exemplary automatic mop bucket may be integrally formed with both the automatic mop and the wet/dry vacuum.

In alternative exemplary embodiments, the exemplary embodiments may be modified to form an autonomous cleaning device. In such arrangements, the exemplary container includes the automatic mop and wet/dry vacuum in operative connection with an underside of the container such that the mop head and the wet/dry vacuum are selectively movable to contact a surface. Further, the exemplary apparatus includes various sensors and processors to determine the condition of a surface and to make a determine whether the mop or wet/dry vacuum is needed. The exemplary apparatus further includes necessary components, devices, and mechanisms to cause raising and lowering of the mop head and the wet/dry vacuum to contact a surface and the actuate any motion for operation of the mop head or wet/dry vacuum. Of course, this arrangement is merely exemplary, and in other embodiments, other features and relationships may be used.

Although a few exemplary embodiments of the present general inventive concept have been illustrated and described, it will be appreciated by those skilled in the art that changes may be made in these exemplary embodiments or combinations of the various features and relationships of the exemplary embodiments may be made to form other embodiments without departing from the principles and spirit of this disclosure, the scope of which is defined in the appended claims and their equivalents.

What is claimed is:

1. An apparatus, comprising:
a container including an interior area configured to house a liquid therein;
a plurality of casters in operative connection with a lower portion of the container to permit the container to be moved about on a floor or other support surface;
a liquid inlet port configured to receive a liquid from an external liquid source into the interior area;
a liquid outlet port configured to discharge liquid from the interior area; and
a sealed chamber enclosing a pump in fluid connection with the interior area and the liquid outlet port, a pump motor to drive the pump, and a power source to provide electrical power to the pump motor,
wherein the pump motor and the power source are in operative connection via at least one circuit, wherein the power source is operatively configured to selectively deliver electrical power to the pump motor via the circuit to cause operation of the pump, and
wherein the pump is thereby selectively operative to draw liquid from the interior area and to cause the liquid to be discharged through the liquid outlet port.

2. The apparatus according to claim 1, further comprising:
at least one filter for removal of debris from the liquid, wherein the filter is in fluid connection with the liquid outlet port.

3. The apparatus according to claim 1, wherein the container further includes a spill resistant rim at an upper portion of the container.

4. The apparatus according to claim 1, wherein the container further includes a bladed mixer disposed within the interior area and a mixer motor sealed from the liquid,
wherein the mixer motor is in operative connection with the power source via the circuit and is operative to cause the bladed mixer to rotate to cause movement of the liquid in the interior area.

5. The apparatus according to claim 1, further comprising:
an automatic mop, wherein the automatic mop is in operative connection with the container and includes:
a mop head,
a liquid discharge line and a liquid discharge port,
a liquid intake line and a liquid intake port,
a mop pump in operative fluid connection with the liquid and a mop motor sealed from the liquid,
wherein the liquid discharge port and the liquid intake port are positioned adjacent to the mop head, and wherein the liquid discharge line extends from the liquid discharge port to the interior area and the liquid intake line extends from the liquid intake port to the interior area,
wherein the mop motor is in operative connection with the circuit and the mop pump, and wherein the mop motor is selectively operative to cause the pump to move liquid from the interior area through the liquid discharge line and out the liquid discharge port and to move liquid from an external surface through the liquid intake port and through the liquid intake line to the interior area.

6. The apparatus according to claim 1, further comprising:
a wet/dry vacuum in operative connection with the container, wherein the wet/dry vacuum is configured to remove liquids or solids from a surface.

7. The apparatus of claim 1, as comprising a bucket for a mop, the apparatus further comprising a wringer with a handle, configured to wring out a mop head positioned within an interior area of the wringer.

8. The apparatus of claim 1, wherein the liquid inlet port and the liquid outlet port comprises a combined liquid inlet port and liquid outlet port with a selectively changeable valve configured to permit the combined liquid inlet port and liquid outlet port to selectively serve as one of a liquid input port and a liquid output port.

9. An apparatus, comprising:
a container including an interior area configured to house a liquid therein;
a plurality of casters in operative connection with a lower portion of the container, to permit movement of the apparatus along a floor or other support surface;
a liquid inlet port configured to receive a liquid from an external liquid source into the interior area;
a liquid outlet port configured to discharge liquid from the interior area; and
a pump in fluid connection with the interior area and the liquid outlet port, the pump being selectively operative to draw liquid from the interior area and be discharged through the liquid outlet port.

10. The apparatus of claim 9, wherein the pump is manually operated.

11. The apparatus of claim 9, wherein the pump is electrically driven.

12. The apparatus of claim 11, further comprising an electric circuit to selectively provide electrical power to drive the electrically driven pump

13. The apparatus of claim 12, further comprising a sealed chamber enclosing the electrically driven pump, along with an electric pump motor that drives the pump and a power source configured to selectively provide electrical power to the electric pump motor.

14. The apparatus of claim 13, wherein the power source comprises a battery and a power switch located on an outside surface of the sealed chamber permits a user to selectively connect the battery to the electric pump motor to operate the electrically driven pump.

15. The apparatus of claim 9, as comprising a bucket for a mop, the apparatus further comprising a wringer with a handle, configured to wring out a mop head positioned within an interior area of the wringer.

16. The apparatus of claim 9, as comprising a bucket for an automatic mop, wherein the automatic mop is in operative connection with the container and includes:
a mop head,
a liquid discharge line and a liquid discharge port,
a liquid intake line and a liquid intake port,
a mop pump in operative fluid connection with the liquid and a mop motor sealed from the liquid,
wherein the liquid discharge port and the liquid intake port are positioned adjacent to the mop head, and wherein the liquid discharge line extends from the liquid discharge port to the interior area and the liquid intake line extends from the liquid intake port to the interior area,
wherein the mop motor is in operative connection with the circuit and the mop pump, and wherein the mop motor is selectively operative to cause the pump to move liquid from the interior area through the liquid discharge line and out the liquid discharge port and to move liquid from an external surface through the liquid intake port and through the liquid intake line to the interior area.

17. A mop bucket, comprising:
a container including an interior area configured to house a liquid therein;
a plurality of casters in operative connection with a lower portion of the container, to permit the mop bucket to be moved about on a floor or other support surface;
a wringer with a handle, configured to wring out a mop head positioned within an interior area of the wringer;
a liquid inlet port configured to receive a liquid from an external liquid source into the interior area;
a liquid outlet port configured to discharge liquid from the interior area; and
a pump in fluid connection with the interior area and the liquid outlet port, the pump being selectively operative to draw liquid from the interior area and to cause the liquid to be discharged through the liquid outlet port.
